(19) United States
(12) Patent Application Publication
(10) Pub. No.: US 2009/0279602 A1
(43) Pub. Date: Nov. 12, 2009

(54) Method, Device and System for Effective Fine Granularity Scalability (FGS) Coding and Decoding of Video Data

(76) Inventor: Ye-Kui Wang, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/918,370

(22) PCT Filed: Mar. 22, 2006
(86) PCT No.: PCT/IB2006/000631

§ 371 Date: Jan. 5, 2009

Related U.S. Application Data
(60) Provisional application No. 60/671,155, filed on Apr. 13, 2005.

(51) Int. Cl. H04N 7/26

(52) U.S. Cl. 375/240.02; 375/E07.126

(57) ABSTRACT

Methods, devices and systems for effective and improved video data scalable coding and/or decoding based on Fine Grain Scalability (FGS) information are disclosed. A method for encoding video data is shown, comprising obtaining video data; generating a base layer picture based on the obtained video data, the base layer picture comprising at least one slice, the slice corresponding to a region within the base layer picture; and generating at least one enhancement layer picture corresponding to the base layer picture, wherein the at least one enhancement layer picture comprises at least one FGS slice corresponding to a region within the enhancement layer picture, wherein the region to which the at least one of said FGS-slices corresponds is different from the region to which the slice in the base layer picture corresponds, encoding the base layer picture and the at least one enhancement layer picture resulting in encoded video data.

### CROSS-REFERENCE TO RELATED APPLICATIONS

This application is the U.S. National Stage of International Application Number PCT/IB2006/000631 filed Mar. 22, 2006 and published Oct. 19, 2006 in English under International Publication Number WO 2006/109116 and claims priority from U.S. Provisional Application Ser. No. 60/671,155 filed Apr. 13, 2005.

### BACKGROUND

1. Technical Field

The present invention relates to the field of video encoding and decoding, and more specifically to scalable video data processing on a fine granularity scalability basis.

2. Discussion of Related Art

Conventional video coding standards (e.g. MPEG-1, H.261/263/264) incorporate motion estimation and motion compensation to remove temporal redundancies between video frames. These concepts are very familiar for skilled readers with a basic understanding of video coding, and will not be described in detail.

The scalable extension to H.264/AVC currently enables fine-grained scalability, according to which the quality of a video sequence may be improved by increasing the bit rate in increments of 10% or less. According to the traditional implementation, each FGS (Five Granularity Scalability) slice must cover the same spatial region as the corresponding slice in its “base layer picture”, i.e. the starting macroblock and the size in number of macroblocks of an FGS slice must be the same as the corresponding slice in its “base layer picture”. Consequently, each FGS plane must have the same number of slices as the “base layer picture”.

The constraint, according to the present state of the art, that each FGS slice must cover the same spatial region as the corresponding slice in its “base layer picture” takes effect on the NAL (Network Abstraction Layer) unit sizes hence disable optimal transport according to known packet loss rate and protocol data unit (PDU) size. Furthermore, the constraint disallows region-of-interest (ROI) FGS enhancement, wherein those interested regions may have better quality than other regions.

### BRIEF SUMMARY

A object hereof is to provide a methodology, a device, and a system for efficiently encoding or decoding, respectively, which overcomes the above mentioned problems of the state of the art and provides an effective and qualitatively improved coding.

The main advantages reside in that an FGS slice can be coded such that the starting macroblock position and the size in number of macroblocks can be decided according to the requirement for optimal transport, for example, such that the size of the slice in number of bytes is close but never exceeds the protocol data unit (PDU) size in bytes, and in that an FGS slice may be coded such that it covers an interested region that is more important or part thereof, and it is coded in a higher quality than non-important regions, or alternatively, only FGS slices covering the interested region are encoded and transmitted.

According to the present invention the constraint that each FGS slice must cover the same spatial region as the corresponding slice in its “base layer picture” is removed. Rather, the region covered by an FGS slice (i.e. the starting macroblock and the size in number of macroblocks) is independent of its base layer picture. Accordingly, any application that applies scalable video coding, wherein FGS slices are supported, will benefit from the inventive step of the present invention.

According to a first aspect, a method for encoding video data is provided, the method comprising obtaining said video data; generating a base layer picture based on said obtained video data, the base layer picture comprising at least one slice, said slice corresponding to a region within said base layer picture; and generating at least one enhancement layer picture corresponding to said base layer picture, wherein said at least one enhancement layer picture comprises at least one fine granularity scalability (FGS) slice, said at least one FGS-slice corresponding to a region within said enhancement layer picture, wherein the region to which said at least one of said FGS-slices corresponds is different from the region to which said slice in the base layer picture corresponds, encoding said base layer picture and said at least one enhancement layer picture resulting in encoded video data.

In a preferred embodiment said at least one FGS slice is a progressive refinement slice as specified in a scalable extension to the video coding standard H.264/AVC.

In a preferred embodiment said generating of said base layer picture and said at least one enhancement layer picture is based on motion information within said video data, said motion information being provided by a motion estimation process.

It is preferred that at least one FGS-slice corresponds to a region of interest (ROI) in a picture.

It is preferred that the number of slices in the said base layer picture and the number of FGS slices in the enhancement layer picture is different.

It is preferred that said FGS-slice is encoded such that it has a size in bytes according to a pre-determined value.

According to a second aspect, a method for scalable decoding of encoded video data is provided, comprising obtaining said encoded video data; identifying a base layer picture and at least one enhancement layer picture within said encoded video data; said base layer picture comprising at least one slice, said slice corresponding to a region within said base layer picture; and at least one enhancement layer picture corresponding to said base layer picture, wherein said at least one enhancement layer picture comprises at least one fine granularity scalability (FGS) slice, said at least one FGS-slice corresponding to a region within said enhancement layer picture, wherein the region to which said at least one of said FGS-slices corresponds is different from the region to which said slice in the base layer picture corresponds, and decoding said encoded video data by combining said base layer picture, said at least one enhancement layer picture resulting in decoded video data.

It is preferred that said at least one FGS slice is a progressive refinement slice as specified in a scalable extension to a video coding standard known as H.264/AVC.

It is preferred that said base layer and said enhancement layer pictures are based on motion information within said encoded video data, said motion information being provided within said encoded video data.

It is preferred that said at least one FGS-slice relates to certain regions of interest of individual pictures within said encoded video data.

It is preferred that said encoded video data does not comprise FGS-slices covering a region not of interest.

It is preferred that said at least one FGS-slice has a size in bytes close to but less than a pre-determined value.

In another aspect there is provided a device, operative according to a method as recited above for encoding.

In another aspect there is provided a device operative according to a method as recited above for decoding.

In another aspect there is provided a system for supporting data transmission according to a method for encoding as above.

In another aspect there is provided a system for supporting data transmission according to a method for decoding as recited above.

There is further provided a data transmission system, according to a third aspect, including at least one encoding device for carrying out a method for scalable encoding video data, comprising obtaining said video data; generating a base layer picture based on said obtained video data, the base layer picture comprising at least one slice, said slice corresponding to a region within said base layer picture; and generating at least one enhancement layer picture corresponding to said base layer picture, wherein said at least one enhancement layer picture comprises at least one fine granularity scalability (FGS) slice, said at least one FGS-slice corresponding to a region within said enhancement layer picture, wherein the region to which said at least one of said FGS-slices corresponds is different from the region to which said slice in the base layer picture corresponds, encoding said base layer picture and said at least one enhancement layer picture resulting in encoded video data, and a decoding device for carrying out a method for scalable decoding of encoded video data, comprising obtaining said encoded video data; identifying a base layer picture and at least one enhancement layer picture within said encoded video data; said base layer picture comprising at least one slice, said slice corresponding to a region within said base layer picture; and at least one enhancement layer picture corresponding to said base layer picture, wherein said at least one enhancement layer picture comprises at least one fine granularity scalability (FGS) slice, said at least one FGS-slice corresponding to a region within said enhancement layer picture, wherein the region to which said at least one of said FGS-slices corresponds is different from the region to which said slice in the base layer picture corresponds, and decoding said encoded video data by combining said base layer picture, said at least one enhancement layer picture resulting in decoded video data.

There is provided a computer readable medium embodying computer program code stored thereon for execution by a computer processor hosted by an electronic device, wherein said computer program code comprises instructions for performing a method for encoding as above according to the first aspect.

Further there is provided a computer readable medium embodying computer program code stored thereon for execution by a computer processor hosted by an electronic device, wherein said computer program code comprises instructions for performing a method for decoding as above according to the second aspect.

Further there is provided a computer readable medium having a data signal at least temporarily stored thereon and encoded or encodable according to a method corresponding to the first aspect, which data signal encoded according to a method corresponding to the first aspect is decodable according to the second aspect.

According to a fourth aspect, there is provided a module for scalable encoding of video data, comprising:

a component for obtaining said video data; a component for generating a base layer picture based on obtained video data; a component for generating at least one enhancement layer picture depending on said obtained video data and said base layer, the base layer picture comprising at least one slice, said slice corresponding to a region within said base layer picture; and at least one enhancement layer picture corresponding to said base layer picture, wherein said at least one enhancement layer picture comprises at least one fine granularity scalability (FGS) slice, said at least one FGS-slice corresponding to a region within said enhancement layer picture; and a component for defining at least one of said one or more generated enhancement FGS-slices in such manner that the region to which said at least one of said FGS-slices corresponds is different from the region to which said slice in the base layer picture corresponds; and a component for encoding said base layer and said at least one enhancement layer resulting in encoded video data.

According to a fifth aspect, there is provided a module for scalable decoding of encoded video data, comprising: a component for obtaining said encoded video data; a component for identifying a base layer picture and at least one enhancement layer picture within said encoded video data; wherein said base layer picture comprises at least one slice, said slice corresponding to a region within said base layer picture; and at least one enhancement layer picture corresponding to said base layer picture, wherein said at least one enhancement layer picture comprises at least one fine granularity scalability (FGS) slice, said at least one FGS-slice corresponding to a region within said enhancement layer picture, wherein the region to which said at least one of said FGS-slices corresponds is different from the region to which said slice in the base layer picture corresponds and a component for decoding said encoded video data by combining said base layer, said at least one enhancement layer resulting in decoded video data.

Further there is provided a computer readable medium having a data signal embodied in a carrier wave and representing a signal encoded according to the first aspect at least temporarily stored thereon, which data signal is decodable according to instructions carried out according to the second aspect.

Thus it is now achieved to provide a method for flexible coding of FGS slices in the sense that the region covered by an FGS slice (i.e. the starting macroblock and the size in number of macroblocks) is independent of its base layer picture. And consequently, each FGS plane can have a different number of slices than the “base layer picture”.

Further advantages will become apparent to the reader of the present invention when reading the detailed description referring to embodiments, based on which the teachings hereof are easily understandable.

Throughout the detailed description and the accompanying drawings same or similar components, units, or devices will be referenced by same reference numerals for clarity purposes.

### BRIEF DESCRIPTION OF THE DRAWINGS

The accompanying drawings are included to provide a further understanding of the teachings hereof, and are incorporated in and constitute a part of this specification. The drawings illustrate embodiments and together with the description serve as detailed explanatory matter. In the drawings,

FIG. 1 schematically illustrates an example block diagram for a portable Consumer electronics (CE) device embodied exemplarily on the basis of a cellular terminal device;

FIG. 2 is a detailed illustration of an encoding principle in accordance with the teachings hereof;

FIG. 3 is a detailed illustration of a decoding principle teachings hereof;

FIG. 4 depicts an operational sequence showing an encoding side in accordance with the teachings hereof;

FIG. 5 depicts an operational sequence showing a decoding side in accordance with the teachings hereof;

FIG. 6 represents a encoding module in accordance with the teachings hereof showing all components;

FIG. 7 represents a decoding module in accordance with the teachings hereof showing all components.

Even though this disclosure describes various embodiments according to the accompanying drawings, it is clear that the teachings hereof are not restricted thereto but it can be modified with benefit of these teachings.

In the following description of the various embodiments, reference is made to the accompanying drawings which form a part thereof, and in which is shown by way of illustration various embodiments in which the teachings hereof may be practiced. It is to be understood that other embodiments may be utilized and structural and functional modifications may be made without departing from the scope hereof. Wherever possible same reference numbers are used throughout drawings and description to refer to similar or like parts.

### DETAILED DESCRIPTION OF EMBODIMENTS

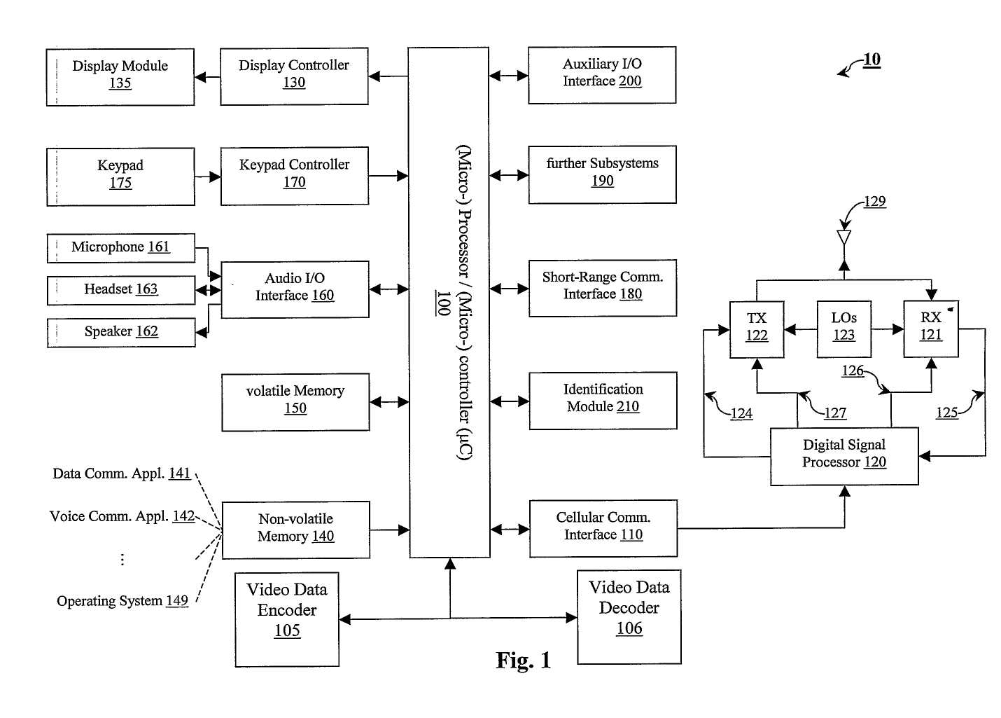

FIG. 1 depicts a typical mobile device according to an embodiment. The mobile device 10 shown in FIG. 1 is capable for cellular data and voice communications. It should be noted that there is no limitation implied by this specific embodiment, which represents by way of illustration only one embodiment out of a multiplicity of possible embodiments. The mobile device 10 includes a (main) microprocessor or microcontroller 100 as well as components associated with the microprocessor controlling the operation of the mobile device. These components include a display controller 130 connecting to a display module 135, a non-volatile memory 140, a volatile memory 150 such as a random access memory (RAM), an audio input/output (I/O) interface 160 connecting to a microphone 161, a speaker 162 and/or a headset 163, a keypad controller 170 connected to a keypad 175 or keyboard, any auxiliary input/output (I/O) interface 200, and a short-range communications interface 180. Such a device also typically includes other device subsystems shown generally at 190.

The mobile device 10 may communicate over a voice network and/or may likewise communicate over a data network, such as any public land mobile networks (PLMNs) in the form of e.g. digital cellular networks, especially GSM (global system for mobile communication) or UMTS (universal mobile telecommunications system). Typically the voice and/or data communication is operated via an air interface, i.e. a cellular communication interface subsystem in cooperation with further components (see above) to a base station (BS) or Node B (not shown) being part of a radio access network (RAN) of the infrastructure of the cellular network. The cellular communication interface subsystem as depicted illustratively with reference to FIG. 1 comprises the cellular interface 110, a digital signal processor (DSP) 120, a receiver (RX) 121, a transmitter (TX) 122, and one or more local oscillators (LOs) 123 and enables the communication with one or more public land mobile networks (PLMNs). The digital signal processor (DSP) 120 sends communication signals 124 to the transmitter (TX) 122 and receives communication signals 125 from the receiver (RX) 121. In addition to processing communication signals, the digital signal processor 120 also provides for receiver control signals 126 and transmitter control signal 127. For example, besides the modulation and demodulation of the signals to be transmitted and signals received, respectively, the gain levels applied to communication signals in the receiver (RX) 121 and transmitter (TX) 122 may be adaptively controlled through automatic gain control algorithms implemented in the digital signal processor (DSP) 120. Other transceiver control algorithms could also be implemented in the digital signal processor (DSP) 120 in order to provide more sophisticated control of the transceiver 122. In case the mobile device 10 communications through the PLMN occur at a single frequency or a closely-spaced set of frequencies, then a single local oscillator (LO) 123 may be used in conjunction with the transmitter (TX) 122 and receiver (RX) 121. Alternatively, if different frequencies are utilized for voice/data communications or transmission versus reception, then a plurality of local oscillators 128 can be used to generate a plurality of corresponding frequencies. Although the antenna 129 depicted in FIG. 1 could be a diversity antenna system (not shown), the mobile device 10 can use a single antenna structure for signal reception as well as transmission as shown. Information, which includes both voice and data information, is communicated to and from the cellular interface 110 via a data link between the interface 110 and the digital signal processor (DSP) 120. The detailed design of the cellular interface 110, such as frequency band, component selection, power level, etc., will be dependent upon the wireless network in which the mobile device 10 is intended to operate.

After any required network registration or activation procedures have been completed, which may involve the subscriber identification module (SIM) 210 required for registration in cellular networks, the mobile device 10 may then send and receive communication signals, including both voice and data signals, over the wireless network. Signals received by the antenna 129 from the wireless network are routed to the receiver 121, which provides for such operations as signal amplification, frequency down conversion, filtering, channel selection, and analog to digital conversion. Analog to digital conversion of a received signal allows more complex communication functions, such as digital demodulation and decoding, to be performed using the digital signal processor (DSP) 120. In a similar manner, signals to be transmitted to the network are processed, including modulation and encoding, for example, by the digital signal processor (DSP) 120 and are then provided to the transmitter 122 for digital to analog conversion, frequency up conversion, filtering, amplification, and transmission to the wireless network via the antenna 129.

The microprocessor/microcontroller (μC) 100, which may also be designated as a device platform microprocessor, manages the functions of the mobile device 10. Operating system software 149 used by the processor 100 is preferably stored in a persistent store such as the non-volatile memory 140, which may be implemented, for example, as a Flash memory, battery backed-up RAM, any other non-volatile storage technology, or any combination thereof. In addition to the operating system 149, which controls low-level functions as well as (graphical) basic user interface functions of the mobile device 10, the non-volatile memory 140 includes a plurality of high-level software application programs or modules, such as a voice communication software application 142, a data communication software application 141, an organizer module (not shown), or any other type of software module (not shown). These modules are executed by the processor 100 and provide a high-level interface between a user of the mobile device 10 and the mobile device 10. This interface typically includes a graphical component provided through the display 135 controlled by a display controller 130 and input/output components provided through a keypad 175 connected via a keypad controller 170 to the processor 100, an auxiliary input/output (I/O) interface 200, and/or a short-range (SR) communication interface 180. The auxiliary I/O interface 200 comprise especially USB (universal serial bus) interface, serial interface, MMC (multimedia card) interface and related interface technologies/standards, and any other standardized or proprietary data communication bus technology, whereas the short-range communication interface radio frequency (RF) low-power interface including especially WLAN (wireless local area network) and Bluetooth communication technology or an IRDA (infrared data access) interface. The RF low-power interface technology referred to herein should especially be understood to include any IEEE 801.xx standard technology, which description is obtainable from the Institute of Electrical and Electronics Engineers. Moreover, the auxiliary I/O interface 200 as well as the short-range communication interface 180 may each represent one or more interfaces supporting one or more input/output interface technologies and communication interface technologies, respectively.

The operating system, specific device software applications or modules, or parts thereof, may be temporarily loaded into a volatile store 150 such as a random access memory (typically implemented on the basis of DRAM (direct random access memory) technology for faster operation. Moreover, received communication signals may also be temporarily stored to volatile memory 150, before permanently writing them to a file system located in the non-volatile memory 140 or any mass storage preferably detachably connected via the auxiliary I/O interface for storing data. It should be understood that the components described above represent typical components of a traditional mobile device 10 embodied herein in form of a cellular phone. Application of the teachings hereof are not limited to these specific components and their implementation depicted merely for the way for illustration and sake of completeness.

An exemplary software application module of the mobile device 10 is a personal information manager application providing PDA (Personal Digital Assistant) functionality including typically a contact manager, calendar, a task manager, and the like. Such a personal information manager is executed by the processor 100, may have access to the components of the mobile device 10, and may interact with other software application modules. For instance, interaction with the voice communication software application allows for managing phone calls, voice mails, etc., and interaction with the data communication software application enables for managing SMS (short message service), MMS (multimedia message service), e-mail communications and other data transmissions. The non-volatile memory 140 preferably provides a file system to facilitate permanent storage of data items on the device including particularly calendar entries, contacts etc. The ability for data communication with networks, e.g. via the cellular interface, the short-range communication interface, or the auxiliary I/O interface enables upload, download, synchronization via such networks.

The application modules 141 to 149 represent device functions or software applications that are configured to be executed by the processor 100. In most known mobile devices, a single processor manages and controls the overall operation of the mobile device as well as all device functions and software applications. Such a concept is applicable for today's mobile devices. Especially the implementation of enhanced multimedia functionalities includes for example reproducing of video streaming applications, manipulating of digital images, and video sequences captured by integrated or detachably connected digital camera functionality but also gaming applications with sophisticated graphics drives the requirement of computational power. One way to deal with the requirement for computational power, which has been pursued in the past, solves the problem for increasing computational power by implementing powerful and universal processor cores. Another approach for providing computational power is to implement two or more independent processor cores, which is a well known methodology in the art. The advantages of several independent processor cores can be immediately appreciated by those skilled in the art. Whereas a universal processor is designed for carrying out a multiplicity of different tasks without specialization to a pre-selection of distinct tasks, a multi-processor arrangement may include one or more universal processors and one or more specialized processors adapted for processing a predefined set of tasks. Nevertheless, the implementation of several processors within one device, especially a mobile device such as mobile device 10, requires traditionally a complete and sophisticated re-design of the components.

In the following, the present disclosure will set forth a concept which allows simple integration of additional processor cores into an existing processing device implementation enabling the omission of expensive complete and sophisticated redesign. The inventive concept will be described with reference to system-on-a-chip (SoC) design. System-on-a-chip (SoC) is a concept of integrating at least numerous (or all) components of a processing device into a single high-integrated chip. Such a system-on-a-chip can contain digital, analog, mixed-signal, and often radio-frequency functions—all on one chip. A typical processing device comprise of a number of integrated circuits that perform different tasks. These integrated circuits may include especially microprocessor, memory, universal asynchronous receiver-transmitters (UARTs), serial/parallel ports, direct memory access (DMA) controllers, and the like. A universal asynchronous receiver-transmitter (UART) translates between parallel bits of data and serial bits. The recent improvements in semiconductor technology caused that very-large-scale integration (VLSI) integrated circuits enable a significant growth in complexity, making it possible to integrate numerous components of a system in a single chip. With reference to FIG. 1, one or more components thereof, e.g. the controllers 130 and 160, the memory components 150 and 140, and one or more of the interfaces 200, 180 and 110, can be integrated together with the processor 100 in a signal chip which forms finally a system-on-a-chip (SoC).

Additionally, said device 10 is equipped with a module 105 for scalable encoding and a module 106 for scalable decoding of video data according to the disclosed operation, according to the teachings hereof. By means of the CPU 100 said modules 105, 106 may be individually used. However, said device 10 may be adapted to perform video data encoding or decoding respectively. Said video data may be received by means of the communication modules of the device or it also may be stored, at least temporarily, within any imaginable storage means within the device 10.

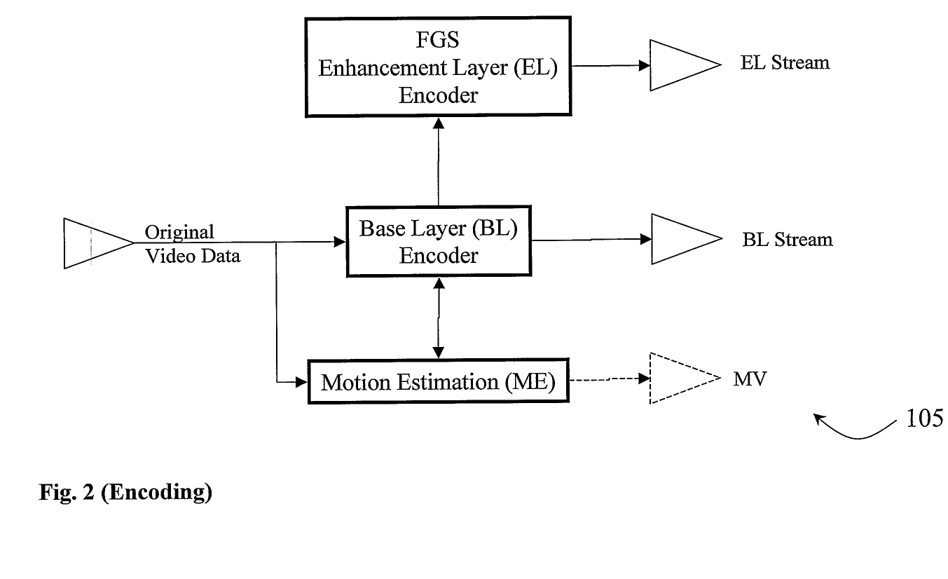

With reference to FIG. 2 a detailed explanation of the FGS encoding principle in accordance with the teachings hereof is depicted. The original, raw video data is used for motion estimation and also for encoding the base layer BL and the corresponding enhancement layers EL. Principally, each EL comprises coded FGS information which enables further picture improvement on the decoder side, for instance. After processing all encoding operations a BL data stream and, if needed, more than one EL data stream having additional FGS information is provided. According to this method, the FGS information is in such manner advantageously encoded so that each FGS slice may cover a different region than the region covered by the corresponding slice in the base layer picture. Thus, it is possible to enhance the picture quality based on FGS information within the EL for a certain region not exactly covered by a set of slices in the base layer picture, thereby enabling region of interest (ROI) image improvement, either by coding FGS slices covering the interested regions with a better quality or by only coding FGS slices covering the interested regions. Optionally, the motion vectors MV resulting from the motion estimation ME may be further processed or sent to a receiver.

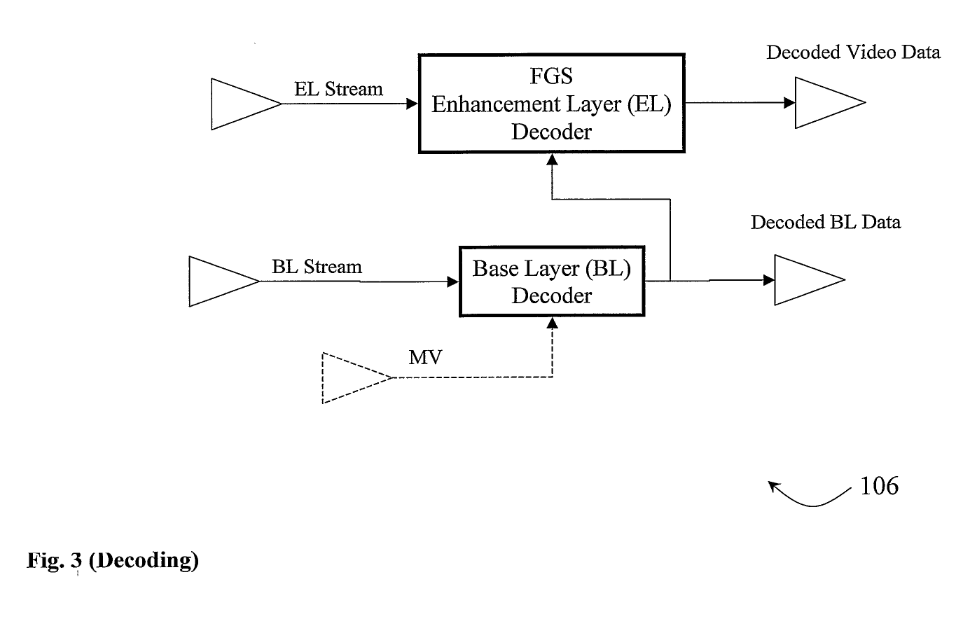

FIG. 3 depicts the FGS decoding principle in accordance with the teachings hereof. After receiving the BL and the EL stream the FGS decoder will provide proper decoding of said scalable encoded video data. By means of the motion vectors MV and the FGS slices within the EL the decoder will decide which part of the picture within the base layer shall be improved according to the FGS information. Thereby, a scalable decoding technique is enabled, while the decoder may decide which picture regions shall take advantage from the FGS information of the EL. In this exemplarily embodiment only one EL is depicted and correspondingly decoded but it is imaginable that the decoder may process a plurality of EL's.

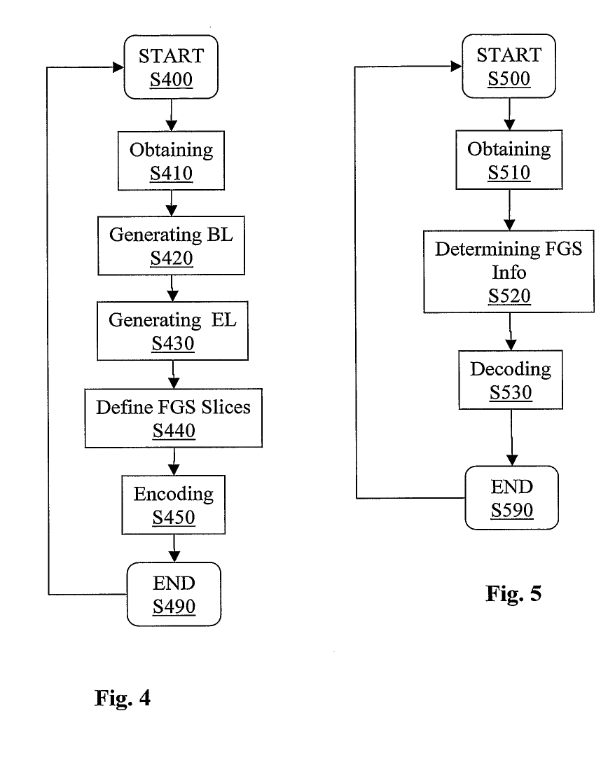

FIG. 4 shows an operational sequence illustrating the general FGS encoding method in accordance with the teachings hereof. In an operation S400 the operational sequence may start. This may correspond to the time as the encoder module will obtain the raw video data stream, for instance from a camera, which is depicted with reference to the operation S410. The next operations will provide scalable video encoding by usage of corresponding FGS information in accordance with the present inventive step of the present operation. The operations S420 and S430 symbolize the generating or creating, respectively from the base layer BL, and if needed, of more then one enhancement layers EL. For each EL FGS information will be defined, S440, wherein said information is embodied within FGS-slices corresponding to certain parts of the base layer picture. After defining all relevant FGS-slices including FGS-information the encoder decides which part of the base layer picture represents the ROI and thus the FGS-information within the slices may exclusively be used only for this picture part, as shown with reference to an operation S440. Other implementations within the scope of the teachings hereof are imaginable as well.

If no further processing is needed the operational sequence may come to an end operation S490, and may be restarted according to a new iteration.

FIG. 5 is an operational sequence of the FGS decoding method in accordance with the teachings hereof. The operational sequence will be started as shown with reference to an operation S500. Next, an obtaining operation S510 is provided corresponding for instance with the receiving of a scalable encoded data stream including FGS information. On the basis of said received and encoded data stream, the decoder will derive S520 all needed information: BL, EL and FGS information embodied in so called FGS-slices.

On the basis of the received FGS-slices, base layer and enhancement layers the decoder is adapted to reconstruct the original sequence S530. According to the teachings hereof the received FGS-information may be used for certain regions of interest within the base layer picture.

If no further processing is needed the operational sequence may come to an end operation S590, and may be restarted according to a new iteration.

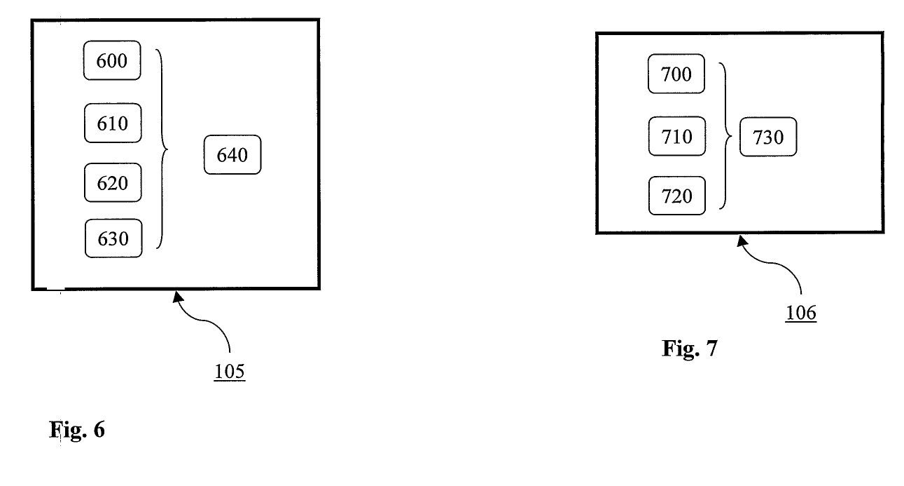

With reference to FIGS. 6 and 7 an encoding and a decoding module in accordance with the teachings hereof are depicted. Said modules may be implemented in form of software, hardware or the like alone or in any combination.

FIG. 6 shows a module 105 for scalable encoding of video data. Said module 105 comprises: a component 600 for obtaining said video data, a component 610 for generating a base layer based on said obtained video data, a component 620 for generating at least one corresponding scalable enhancement layer depending on said video data and said base layer, wherein said at least one enhancement layer comprises fine granularity scalability (FGS) information based on one or more enhancement FGS-slices, said FGS-slices describing certain regions within said base layer; and a component 630 for defining at least one of said one or more generated enhancement FGS-slices in such manner that said at least one generated enhancement FGS-slice covers a different region that the region covered by the corresponding slice in the base layer picture; and a component 640 for encoding said base layer and said at least one enhancement layer resulting in encoded video data.

FIG. 7 shows a module 106 for scalable decoding of encoded video data, comprising: a component 700 for obtaining said encoded video data, a component 710 for identifying a base layer and a plurality of enhancement layers within said encoded video data, a component 720 for determining fine granularity scalability (FGS) information relating to said base layer within said plurality of enhancement layers, wherein said FGS-information comprises at least one FGS-slice describing certain regions within said base layer and at least one of said FGS-slices covers a different region than the region covered by said the corresponding slice in the base layer picture, a component 730 for decoding said encoded video data by combining said base layer, said plurality of enhancement layers and said FGS-information resulting in decoded video data.

Even though the teachings hereof are described above with reference to embodiments according to the accompanying drawings, it is clear that the scope thereof is not thereby restricted but can be modified in several ways.

1. Method for encoding video data, the method comprising:
obtaining said video data;
generating a base layer picture based on said obtained video data, the base layer picture comprising at least one slice, said slice corresponding to a region within said base layer picture; and
generating at least one enhancement layer picture corresponding to said base layer picture, wherein said at least one enhancement layer picture comprises at least one fine granularity scalability slice, said at least one fine grain scalability slice corresponding to a region within said enhancement layer picture,
wherein the region to which said at least one of said fine grain scalability slices corresponds is different from the region to which said slice in the base layer picture corresponds,
encoding said base layer picture and said at least one enhancement layer picture resulting in encoded video data.

2. The method of claim 1, wherein said at least one fine grain scalability slice is a progressive refinement slice as specified in a scalable extension to the video coding standard H.264/AVC.

3. Method according to claim 1, wherein said generating of said base layer picture and said at least one enhancement layer picture is based on motion information within said video data, said motion information being provided by a motion estimation process.

4. Method according to claim 1, wherein said at least one fine grain scalability slice corresponds to a region of interest in a picture.

5. Method according to claim 1, wherein the number of slices in the said base layer picture and the number of fine grain scalability slices in the enhancement layer picture is different.

6. Method according to claim 1, wherein said fine grain scalability slice is encoded such that it has a size in bytes according to a pre-determined value.

7. Method for scalable decoding of encoded video data, comprising:
obtaining said encoded video data;
identifying a base layer picture and at least one enhancement layer picture within said encoded video data;
said base layer picture comprising at least one slice, said slice corresponding to a region within said base layer picture; and at least one enhancement layer picture corresponding to said base layer picture,
wherein said at least one enhancement layer picture comprises at least one fine granularity scalability slice, said at least one fine grain scalability slice corresponding to a region within said enhancement layer picture,
wherein the region to which said at least one of said fine grain scalability slices corresponds is different from the region to which said slice in the base layer picture corresponds,
decoding said encoded video data by combining said base layer picture, said at least one enhancement layer picture resulting in decoded video data.

8. The method of claim 7, wherein said at least one fine grain scalability slice is a progressive refinement slice as specified in a scalable extension to a video coding standard known as H.264/AVC.

9. Method according to claim 7, wherein said base layer and said enhancement layer pictures are based on motion information within said encoded video data, said motion information being provided within said encoded video data.

10. Method according to claim 7, wherein said at least one fine grain scalability slice relates to certain regions of interest of individual pictures within said encoded video data.

11. Method according to claim 7, wherein said encoded video data does not comprise fine grain scalability slices covering a region not of interest.

12. Method according to claim 7, wherein said at least one fine grain scalability slice has a size in bytes close to but less than a pre-determined value.

13. A device, operative according to a method as recited in claim 1.

14. A device, operative according to a method as recited in claim 7.

15. A system for supporting data transmission according to a method as in recited in claim 1.

16. A system for supporting data transmission according to a method as recited in claim 7.

17. A data transmission system, including at least one encoding device for carrying out a method for scalable encoding video data, comprising:
obtaining said video data;
generating a base layer picture based on said obtained video data, the base layer picture comprising at least one slice, said slice corresponding to a region within said base layer picture; and
generating at least one enhancement layer picture corresponding to said base layer picture, wherein said at least one enhancement layer picture comprises at least one fine granularity scalability slice, said at least one fine grain scalability slice corresponding to a region within said enhancement layer picture,
wherein the region to which said at least one of said fine grain scalability slices corresponds is different from the region to which said slice in the base layer picture corresponds,
encoding said base layer picture and said at least one enhancement layer picture resulting in encoded video data, and
a decoding device for carrying out a method for scalable decoding of encoded video data, comprising:
obtaining said encoded video data;
identifying a base layer picture and at least one enhancement layer picture within said encoded video data;
said base layer picture comprising at least one slice, said slice corresponding to a region within said base layer picture; and at least one enhancement layer picture corresponding to said base layer picture,
wherein said at least one enhancement layer picture comprises at least one fine granularity scalability slice, said at least one fine grain scalability slice corresponding to a region within said enhancement layer picture,
wherein the region to which said at least one of said fine grain scalability slices corresponds is different from the region to which said slice in the base layer picture corresponds,
decoding said encoded video data by combining said base layer picture, said at least one enhancement layer picture resulting in decoded video data.

18. A computer readable medium embodying computer program code stored thereon for execution by a computer processor hosted by an electronic device, wherein said computer program code comprises instructions for performing a method according to claim 1.

19. A computer readable medium embodying computer program code stored thereon for execution by a computer processor hosted by an electronic device, wherein said computer program code comprises instructions for performing a method according to claim 7.

20. (canceled)

21. Module for scalable encoding of video data, comprising:
a component for obtaining said video data;
a component for generating a base layer picture based on obtained video data;
a component for generating at least one enhancement layer picture depending on said obtained video data and said base layer, the base layer picture comprising at least one slice, said slice corresponding to a region within said base layer picture; and at least one enhancement layer picture corresponding to said base layer picture, wherein said at least one enhancement layer picture comprises at least one fine granularity scalability slice, said at least one fine granularity scalability slice corresponding to a region within said enhancement layer picture; and
a component for defining at least one of said one or more generated enhancement fine granularity scalability slices in such manner that the region to which said at least one of said fine granularity scalability slices corresponds is different from the region to which said slice in the base layer picture corresponds; and
a component for encoding said base layer and said at least one enhancement layer resulting in encoded video data.

22. Module for scalable decoding of encoded video data, comprising:
a component for obtaining said encoded video data;
a component for identifying a base layer picture and at least one enhancement layer picture within said encoded video data; wherein said base layer picture comprises at least one slice, said slice corresponding to a region within said base layer picture; and at least one enhancement layer picture corresponding to said base layer picture, wherein said at least one enhancement layer picture comprises at least one fine granularity scalability slice, said at least one fine granularity scalability slices corresponding to a region within said enhancement layer picture,
wherein the region to which said at least one of said fine granularity scalability slices corresponds is different from the region to which said slice in the base layer picture corresponds and
a component for decoding said encoded video data by combining said base layer, said at least one enhancement layer resulting in decoded video data.

23. (canceled)
